(19) United States
(12) Patent Application Publication
(10) Pub. No.: US 2025/0086202 A1
(43) Pub. Date: Mar. 13, 2025

(54) ROBUST TUNER FOR DATABASE CLUSTER CONFIGURATION TUNING IN PRODUCTION

(71) Applicant: Microsoft Technology Licensing, LLC, Redmond, WA (US)

(72) Inventors: Yiwen ZHU, San Francisco, CA (US); Subramaniam Venkatraman KRISHNAN, Santa Clara, CA (US); Weihan TANG, Beijing (CN); Tengfei HUANG, Beijing (CN); Rui FANG, Beijing (CN); Rahul Kumar CHALLAPALLI, San Jose, CA (US); Mo LIU, San Jose, CA (US); Long TIAN, Beijing (CN); Karuna Sagar KRISHNA, Issaquah, WA (US); Estera Zaneta KOT, Redmond, WA (US); Xin HE, Beijing (CN); Ashit R. GOSALIA, Sammamish, WA (US); Dario Kikuchi BERNAL, Cambridge, MA (US); Aditya LAKRA, Boston, MA (US); Arshdeep SEKHON, Fort Mill, SC (US); Sule KAHRAMAN, Boston, MA (US); Carlo Aldo CURINO, Woodinville, WA (US); Brian Paul KROTH, Madison, WI (US); Rathijit SEN, Redmond, WA (US); Andreas Christian MUELLER, Los Gatos, CA (US); Shaily Jignesh FOZDAR, New York, NY (US); Dhruv Harendra RELWANI, Bellevue, WA (US); Xiang LI, Beijing (CN); Sergiy MATUSEVYCH, Redmond, WA (US)

(21) Appl. No.: 18/466,524

(22) Filed: Sep. 13, 2023

(51) Int. Cl. G06F 16/28; G06F 11/34; G06F 16/2455

(52) U.S. Cl. CPC G06F 16/285; G06F 11/3414; G06F 16/2455

(57) ABSTRACT

Systems, methods and computer-readable memory devices are provided for greater efficiency in the configuration of a database cluster for performing a query workload. A database cluster configuration system is provided that includes a database cluster comprising one or more compute resources configured to perform database queries. A query workload comprising a plurality of queries is received. An initial workload-level configuration is applied. For each query of the query workload, a query-level configuration is generated using a query configuration model corresponding to each query in a contextual Bayesian optimization with centroid learning while also leveraging the query plan for each executing query for query characterization and including application of virtual operators. Query events are collected and used to update the corresponding query configuration model. The workload-level configuration is updated based on the query events and cached for use during a subsequent execution of the workload.

### BACKGROUND

“Cloud computing” refers to the on-demand availability of computer system resources (e.g., applications, services, processors, storage devices, file systems, and databases) over the Internet and data stored in cloud storage. Servers hosting cloud-based resources may be referred to as “cloud-based servers” (or “cloud servers”). A “cloud computing service” refers to an administrative service (implemented in hardware that executes in software and/or firmware) that manages a set of cloud computing computer system resources.

Cloud computing platforms include quantities of cloud servers, cloud storage, and further cloud computing resources that are managed by a cloud computing service. Cloud computing platforms offer higher efficiency, greater flexibility, lower costs, and better performance for applications and services relative to “on-premises” servers and storage. Accordingly, users are shifting away from locally maintaining applications, services, and data and migrating to cloud computing platforms. One of the pillars of cloud services are compute resources, which are used to execute code, run applications, and/or run workloads in a cloud computing platform. Such compute resources may be made available to users in sets, also referred to as “clusters.”

“Big data” refers to data sets too large or complex to be handled by traditional data-processing application software. Big data philosophy encompasses unstructured, semi-structured and structured data, with the main focus, however, being on unstructured data. Within big data, the term “size” is a constantly moving target. As of 2012, the term “size” ranged from a few dozen terabytes to many zettabytes of data. Big data requires a set of techniques and technologies with new forms of integration to reveal insights from datasets that are diverse, complex, and of a massive scale. Apache Spark™ is one example of an open-source, unified analytics engine for large-scale data processing, and has become the de-facto standard for processing due to its ease of use and scalability.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods and computer-readable memory devices are provided for greater efficiency and adaptability in the configuration of a database cluster for performing a query workload.

In an example aspect, a database cluster configuration system is provided that includes a database cluster comprising one or more compute resources configured to perform database queries, a backend configuration engine including an event store, a model store and a model updater, a client configuration engine including a query processor and a query event listener. The query processor is coupled to the model store and is configured to receive one or more query configuration models therefrom. The client configuration engine is further coupled to the database cluster.

In a further example aspect, the client configuration engine is configured to receive a query workload, select, through the query processor, a query configuration for each query of the query workload from a plurality of query configuration candidates generated by a baseline query configuration model received from the model store, and execute by the database cluster each query of the query workload using the selected query configuration.

In an additional example aspect, the query event listener is configured to collect query events corresponding to each executed query of the query workload, and to provide the query events to the event store. The model updater is configured to receive the query features from the events store and to update the query configuration model based on the query features.

In a further example aspect, the baseline query configuration model is configured to select the plurality of query configuration candidates based on execution measurements of a plurality of predetermined query workloads comprising a plurality of queries, executed across a predetermined matrix of configurations.

In an additional example aspect, the backend configuration engine further includes a workload-level configuration generator and a workload-level configuration store. The workload-level configuration generator is configured to generate and cache a workload-level configuration based on the collected query features of each query of the query workload, and thereafter store the workload-level configuration in the workload-level configuration store.

In a further example aspect, the client configuration engine is further configured to select, for subsequent executions of the query workload, the cached workload-level configuration from the workload-level configuration store, and to allocate the one or more compute resources for the database cluster based on the selected cached workload-level configuration. The backend configuration engine is further configured to update the selected cached workload-level configuration based on the collected query features.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 depicts a block diagram of a database cluster configuration system, according to an embodiment.

FIG. 2 depicts a flowchart of an example method for operating a database cluster configuration system, according to an embodiment.

FIG. 3 depicts a flowchart of a refinement to the example method of FIG. 2 for operating a database cluster configuration system, according to an embodiment.

FIG. 4 depicts a flowchart of a further refinement to the example method of FIG. 2 for operating a database cluster configuration system, according to an embodiment, according to an embodiment.

FIG. 5 depicts an example artificial neuron suitable for use in a deep neural network (“DNN”), according to an embodiment.

FIG. 6 depicts an example DNN composed of artificial neurons, according to an embodiment.

FIG. 7 is a block diagram of an example computer system in which embodiments may be implemented.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Apache Spark™ has emerged as a popular big data processing engine due to its speed, scalability, and ease of use. It has become the go-to tool for handling large-scale data processing tasks, such as data mining, machine learning, and real-time analytics. With the increasing adoption of cloud computing, Apache Spark™ has also found a place in the cloud, with various Apache Spark™ offerings on cloud platforms, such as Microsoft Azure®, among others. Such offerings provide easy access to Apache Spark™ clusters and take away the burden of managing the infrastructure.

Configuring Apache Spark™ for optimal performance, however, can be challenging and time consuming, especially in production settings. For example, the query performance of some workloads can be very sensitive to changes in configuration settings, which may result in performance regressions rather than improvement. Furthermore, possible configuration settings are numerous and determining optimal settings manually through trial and error is labor intensive and error prone.

When configured in a computing framework that runs on a cluster of machines, the performance of Apache Spark™ query workloads depends heavily on the configuration of the runtime environment, and such configurations are notoriously difficult to tune. At the query workload level, configuration settings such as spark.executor.instances and spark.executor.memory define the number and sizes of the Apache Spark™ executors respectively. In general, allocating a larger quantity of resources implies faster processing whereas insufficient resources lead to poor performance. However, it is general impractical and undesirable to allocate too many resources due to, for example, cost considerations. Furthermore, overprovisioning may also result in worse performance or performance regression. Therefore, a sweet spot that strikes the balance between performance and cost is desired.

Apache Spark™ configuration settings also can have significant performance impacts at the query level (i.e., for a given query of the query workload). For example, configurations such as spark.sql.shuffle.partitions can be tuned to significantly impact the performance of a query, and proper optimization at the query level may, therefore, lead to a significant performance increase for the workload as a whole.

Embodiments disclosed herein integrate an autotune feature into the big data processing engines (such as the Apache Spark™ platform provided by cloud services, such as Microsoft Azure®), while reducing the effort needed from customers. Despite the possibility of continuously improving query workload performance over time, there are practical concerns that are addressed to enable an autotune feature can be used in production scenarios. Amongst these concerns are issues related to accessing customer workload/queries/data, the risk of performance regression and a lack of information at application/workload startup. Each is discussed in turn below.

Prior methods of performance tuning require rounds of “flighting” wherein customer workloads are repeatedly run to build an accurate performance model or determine the most important configurations based on the query composition of the workload. This approach is, however, impractical since it requires additional consent from customers, creates extra costs, and repeated execution could result in data overwriting issues that subsequently affect execution of the customers' production workloads. Furthermore, it adds substantial complexity to the system design.

Performance regression in execution of customer workloads is not only wasteful of time and resources, but may constitute violation of one or more Service Level Agreements (SLAs) between customers and cloud operators. Such SLAs contractually oblige the cloud service provider to provide a minimum level of performance, availability and reliability. As such, significant performance regressions can be a serious concern. Using a black-box machine learning methodology wherein a model is pre-trained and thereafter invariant or insensitive to changes in workload can be risky particularly where the model was trained on inadequate or noisy data. This can result in the suggestion of configurations that lead to failures or significant performance regressions.

Another practical consideration is the lack of information at application/workload start-up time. At start-up, there is no information about the query composition of the workload and yet several application-level configurations need to be set up front, such as the number or sizes of the executors.

Embodiments disclosed herein address these considerations in a number of ways. For example, although Bayesian optimization (“BO”) has previously been applied to configuration tuning applications, it suffers from the risk of performance regression as described above. Embodiments address this shortcoming by applying a centroid learning (“CL”) algorithm that significantly reduces the likelihood of regressions. Moreover, the centroid learning algorithm significantly reduces candidate search space thereby improving latency for the configuration inference process.

To address the concerns related to customer data privacy, embodiments disclosed herein employ baseline model trained offline using open source benchmark queries thereby gaining a better understanding of the performance impacts various configurations changes will have for different queries.

Embodiments address the challenge of missing information at application/workload startup by pre-computing the workload/application level configurations. More specifically, embodiments are configured to compute and cache a configuration upon completion of the workload thereby enabling the cached configuration to quickly be applied the next time the workload executes.

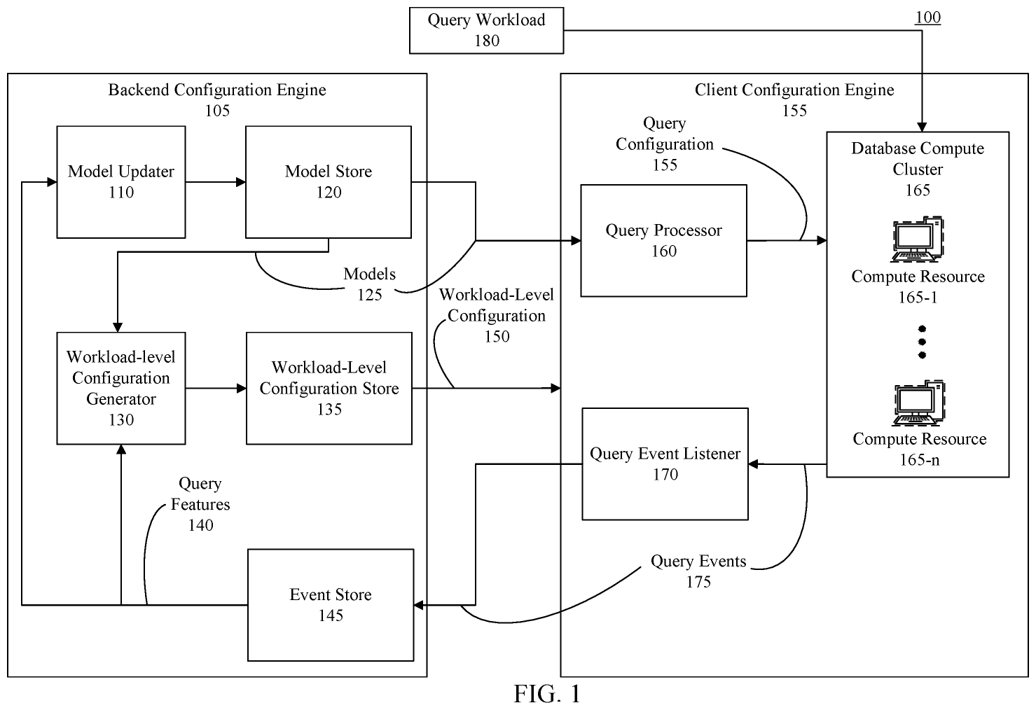

A database cluster configuration system that implements some or all of the above-described embodiments may be constructed in various ways. For example, FIG. 1 depicts a block diagram view of a database cluster configuration system 100, according to an embodiment. In FIG. 1, database cluster configuration system 100 includes a backend configuration engine 105 and a client configuration engine 155. Backend configuration engine 105 includes a model updater 110, a model store 120, a workload-level configuration generator 130, a workload-level configuration store 135 and an event store 145. Client configuration engine 155 includes a query processor 160, a query event listener 170 and a database compute cluster 165. Other structural and operational embodiments will be apparent to persons skilled in the relevant art(s) based on the following discussion regarding database cluster configuration system 100 as depicted in FIG. 1.

The end-to-end process of configuration tuning as performed by database cluster configuration system 100 consists of two phases: (1) an offline phase and (2) an online phase. In the offline phase, a flighting pipeline is configured to execute a selection of open-sourced benchmarks. For example, TPC-DS is a decision support benchmark made available by the Transaction Processing Performance Council (“TPC”) that models several generally applicable aspects of a decision support system, including queries and data maintenance. The TPC-DS benchmark results measure query response time, query throughput and data maintenance performance for a given hardware, operating system, and data processing system configuration under a controlled, complex workload.

The goal of the flighting pipeline is to collect as much as possible training data that can help better understand the performance of different queries under different configurations, and the data is used to build a baseline model that is a regression model to predict the performance under different contexts (the characterization of the query) and different configuration settings. The baseline model is thereafter stored in model store 120 and used as a surrogate model in a Bayesian optimization at iteration 0 for a warm start, in an embodiment, and as will be described further herein below. The net effect of the baseline model is that the learning from benchmark workloads may be leveraged by the customer workloads to improve the quality of configuration suggestions at early iterations (i.e., before the model is updated during subsequent iterations to reflect the quality of the configuration suggestions as applied to the actual customer workloads).

In the online process, if customers enable the “autotune” feature, upon the application/workload starts, embodiments will recommend Spark configuration settings, apply such configuration settings to the workload, and when the application/workload finishes, update the surrogate models. The online phase of database cluster configuration system 100 as shown in FIG. 1 will now be described at a high level with further details provided thereafter. In an embodiment, backend configuration engine 105 may comprise a set of cloud computing resources that ingests query events 175 via event store 145, trains ML models 125 and provides a way to infer the optimal Spark configurations from these models. The client configuration engine 155 run on customers' Spark clusters (i.e., compute resource(s) 165-1 through 165-n of database compute cluster 165) by fetching model files 125 from model store 120 via query processor 160 and workload-level configuration 150 from workload-level configuration store 135, and ultimately compute the ML inferences required to optimize the query-level configurations. The algorithms used to perform these functions are discussed further herein below.

With continued references to database cluster configuration system 100 of FIG. 1, query workload 180 includes autotune-specific parameters (application identifier, job recurrent ID, etc.) that are passed to database compute cluster 165 as part of the payload. These parameters are used by query processor 160 and query event listener 170 to download pre-computed optimal workload-level configurations (e.g., workload-level configuration 150 such as number of executors, executor sizes, etc.) and the ML model files (e.g., models 125), and upon workload completion write query events 175 that capture the details of the actual job run to event store 145. In embodiments, event store 145 may be configured to thereafter generate query features 140 which are subsequently used by model updater 110 to retrain the ML model and by workload-level configuration generator 130 to compute the optimal workload-level configurations. For each workload, workload-level configuration 150 is provided to and applied by client configuration engine 155. Query event listener 170 is configured to intercept each query before the physical planning process and use the models 125 to determine the optimal configs to be applied. Models 125 will now be further described.

As described above, embodiments generate a baseline surrogate model trained using benchmark workloads that can thereafter be applied to unseen workloads. Embodiments employ workload embedding to better characterize the workloads and use them as the “context” in contextual Bayesian optimization (“CBO”). The surrogate model that guides the Bayesian optimization is a regression model that predicts a target variable (e.g., the query execution time) as a function of the context (e.g., the workload embedding) as well as the parameters to tune. A better workload characterization can significantly improve the tuning performance for unseen workloads. The intuition is that given the same context, the workloads are expected to observe similar behavior (in terms of resulting performance for a given set of configurations).

Embodiments may implement one of many workload embedding schemas to extract query information from the query optimizer that is available at query plan compilation time. In an embodiment, query processor 160 may be configured to extract such query information to generate the workload embeddings for the workload. Query information may include, for example, the estimated cardinality for the root node operator, the total input cardinality for all the leave node operators, and the count of operator occurrences in the execution plan. Conceptually, embodiments may employ a virtual operator to further distinguish between different query plan operators with different input/output sizes that may in turn lead to a vectorization of the execution plan at a finer-granularity level. That is, a given physical query operator within a query plan for a query of workload 180 may be split into a few virtual operators based on the characteristics such input and output row count estimated by the optimizer. For example, a virtual operator may be introduced for each physical filter operator of the query plan depending on the sizes of the inputs and outputs. For example, physical filter operators that have a large number of inputs but a relatively small number of outputs (e.g., output rows comprise 10% of the input rows) may be represented by one type of virtual operators, whereas another virtual operator may be employed where the outputs are relatively large as compared to the inputs (e.g., output rows comprise 80% of the input rows). Thereafter, virtual operator counts may be uses as part of the workload embeddings described above to, for example, fine tune the clustering threshold for input size and output size based on the end-to-end tuning performance.

As described above, embodiments are configured to tune both the workload-level configuration applicable to an entire query workload, and the query-level configuration applicable to a given query within the workload. Query-level configuration optimization is performed in the following general manner.

For the first iteration of the query-level configuration tuning, the baseline model developed described above is used as the surrogate model to select the best query configuration. As described in further detail below, different acquisition functions have been commonly used as the criteria for selecting the best query configuration. At inference time, in an embodiment, query processor 160 may be configured to use the workload embedding derived from the query compilation information from the optimizer, select the candidate query configuration that maximizes the acquisition function given the fixed context (i.e., the workload embedding from the query to be tuned), apply the selected configuration and execute the query using the applied configuration. Upon finishing the query execution, the surrogate model will be updated with the new observations made by query event listener 170 and passed to model updater 110 via event store 145. Over time, the tuning process will train the model to be more and more tailored to this specific query. In an embodiment, one surrogate model is maintained per query as identified by its query signature. To ensure data privacy and security, embodiments may be configured such that data is not shared across different users, therefore, the models will be strictly trained with data from the baseline model as well as query traces from the same user.

A traditional contextual Bayesian optimization (“CBO”) method even when used with a baseline model described herein above still may suffer from performance regression during the tuning process which is unacceptable in a production scenario. To address this issue, embodiments restrain the search space for the new candidate configurations based on a centroid learning algorithm where the optimization algorithm only explores candidates in the neighborhood of a current centroid. In embodiments, the default configuration has been well-tuned and the centroid starts from this configuration. With reference to database cluster configuration system 100 of FIG. 1, embodiments may perform the end-to-end tuning process with centroid learning in the following general manner. Upon submission of query workload 180 and as the first query of query workload 180 is being readied to execute, query processor 160 fetches the baseline model described herein from model store 120 for the first iteration of tuning. The neighborhood around the default configuration described immediately is used as the sub-space to generate configuration candidates and based on the surrogate model, the best candidate with the highest acquisition function will be selected and applied to the submitted query. Upon the completion of the query, new records with observed performance gathered by query event listener 170 will be logged to event store 145 and the surrogate model will be updated by model updater 110, in an embodiment. With the new observations, the centroid is updated and during the next iteration (i.e., execution of the query), the next set of candidates will be generated around the updated centroid (step 4). And this iterative tuning process will continuously run with each new submission of the same query.

We turn now to a description of an example algorithm implementing contextual Bayesian optimization with centroid learning, according to an embodiment. For example, consider the following pseudo-code listing of a contextual Bayesian optimization with centroid learning algorithm that may be implemented in embodiments:

Algorithm-1: Contextual Bayesian Optimization
with Centroid Learning

| Inputs: | |
|---|---|
| | Initial centroid e₀ |
| | Centroid step size α |
| | Candidate step size β |
| | Scoring function g(c) of candidate c |
| | Acquisition function f |
| 1: | eₜ ← e₀ |
| 2: | while NOT stop criterion do { |
| 3: | generate candidates near eₜ based on β: |
| | C = {c⁽¹⁾, ..., c⁽ⁿ⁾}; |
| 4: | select best candidate using acquisition function: |
| | cₜ₊₁ = arg max c ∈ C f(c); |
| 5: | execute query with cₜ₊₁; |
| 6: | if g(cₜ₊₁) > g(cₜ) then |
| 7: | eₜ₊₁ ← cₜ₊₁; |
| 8: | else |
| 9: | calculate gradient: μ = cₜ₊₁ − eₜ; |
| 10: | update centroid: eₜ₊₁ ← eₜ − α · μ; |
| 11: | update current candidate: cₜ ← cₜ₊₁; |
| 12: | } |

With reference to Algorithm-1 shown above, inputs include an initial centroid, a centroid step size, a candidate step size, a scoring function for a given candidate and an acquisition function. At line 1, the centroid for the first iteration eₜ is initialized to be the initial centroid e₀. At line 2, a while loop is initiated. This loop executes continuously while the query workload is executing so ordinarily, the stop criterion is just whether all queries of the workload have completed. A set of candidates C near eₜ is generated at line 3 based on β.

At line 4, the acquisition function ƒ is used to evaluate each candidate with the best candidate being selected. Acquisition function ƒ is, as known in the art, a function that is relatively inexpensive to execute that nevertheless selects candidates near the ideal as dictated by Bayesian decision theory. Such an acquisition function may employ any of a number of different strategies for identifying a preferred candidate for the current iteration. For example, acquisition function ƒ may implement and reflect the probability of improvement, expected improvement, an entropy search approach, or be based on an upper confidence bound as known in the art of Bayesian optimization.

At line 5, the query is executed using the candidate selected at line 4. At line 6, scoring function g( ) is used to evaluate whether the selected candidate configuration performed better than the configuration used in the last iteration. Scoring function g( ) typically just reflects the query execution time with faster execution time preferred. In other embodiments, however, scoring function g( ) may instead measure other performance metrics such as compute cycles, memory consumption, I/O to and from memory or other storage, or any other metric that impact performance or cost. Likewise, scoring function g( ) may reflect some combination of performance metrics to balance performance vs. cost.

If the current candidate is better than the last candidate as indicated by the scoring function g( ) then centroid for the next iteration is assigned to be the current candidate as shown in line 7 of Algorithm-1 above.

In the event, however, that the current configuration candidate is actually worse than the previous candidate indicating that the optimization moved in a “bad” direction, then the new centroid is selected from the opposite direction at line 10 based on the gradient calculated at line 9. The net effect is similar to employing gradient descent in a deep neural network thereby improving the likelihood of jumping out of a local minimum.

With continued reference to database cluster configuration system 100 of FIG. 1, workload-level configuration tuning will now be described. A workload-level configuration may specify, for example, the number of executor instances (e.g., number of compute resource(s) 165-1 to 165-n of database compute cluster 165) or the number of processor cores to dedicate to executing the workload. The workload-level configuration is different from the query-level configuration for the following reasons. First, there is a constraint for a workload with multiple queries that across the queries, the workload-level configuration must remain constant whereas the query-level configuration may vary. Furthermore, the workload embedding estimated from the query optimizer as described above is only available while the query is executed and after the query optimizer generates a query plan. When the workload starts, however, there is no information about the queries to come and thus workload embedding is not available.

To address the above issues, the CBO algorithm described above as Algorithm-1 must be modified to generate a joint optimization of both workload-level configurations and query-level configurations. Furthermore, embodiments may be configured to pre-compute the workload-level configuration at the end of each application completion in the following general manner.

As mentioned above, when a query workload such as query workload 180 is submitted, there is no workload embedding available. However, a query workload is generally executed numerous times and “historic” query information (i.e., the workload embedding from the queries that were executed the last time the query workload was executed) may be leveraged. In this manner, all the workload embeddings for a given query workload become available for generating a workload-level configuration. In an embodiment, the workload embeddings could be saved and used to determine the optimal workload-level configuration the next time the query workload is submitted and executed. However, all the information required to determine the workload-level configuration is already available when the execution of the query workload completes, and hence the optimal workload-level configuration for the query workload may be “pre-computed” and cached for use the next time the query workload is executed. Said another way, when a query workload completes execution, an “app-cache” may be generated that indicates the optimal workload-level configuration for the query workload, and this configuration will be fetched from the app-cache and applied the next time the query workload is submitted. With reference to database cluster configuration system 100 as depicted in FIG. 1, the “app-cache” is included within workload-level configuration store 135, in an embodiment. In this manner, the generation of an optimal workload-level configuration is no longer on the hot path of the query workload submission, and the latency of configuration inference is significantly reduced.

In an embodiment, database cluster configuration system 100 as shown in FIG. 1 may employ Algorithm-2 as shown below.

Algorithm-2: Workload-level Configuration Cache Generation

| Inputs: | |
|---|---|
| | Number of workload-level candidates M |
| | Number of query-level candidates N |
| | Set of queries Q comprising the queries of the workload |
| | Scoring function f_{q}(c) for each query q ∈ Q |
| Output: | |
| | Best workload-level configuration candidate |
| 1: | V ← generate M workload-level configuration candidates |
| 2: | for q ∈ Q do { |
| 3: | W_{q} ← generate N query-level configuration candidates |
| | near the |
| | centroid of q; |
| | // Cartesian product of workload-level and query-level |
| | configurations |
| | // for each query |
| 4: | C_{q} (ν) ← {ν × w_{q} \| w_{q} ∈ W_{q} }, ∀_{ν} ∈ V; |
| | // Configuration candidate with the best acquisition |
| | function for |
| | // query q given workload-level configuration ν |
| 5: | c*_{q}(ν) ← arg max_{c ∈ Cq(ν)} f_{q}(c); |
| 6: | } |
| 7: | for ν ∈ V do { |
| 8: | F(ν) ← Σ_{q∈Q} f_{q}(c*_{q}(ν)); |
| | // Score each workload-level configuration candidate |
| 9: | } |
| 10: | return arg max_{ν ∈ v} F(ν) |
| | // return the best workload-level configuration candidate |

Algorithm-2 computes the app-cache by performing a joint optimization across all combinations of query-level and workload-level configurations to estimate the optimal app-level configuration. Algorithm-2 operates as follows. Algorithm-2 accepts a number of inputs: the number of workload-level candidates M, the number of query-level candidates N, a set of queries Q comprising the queries of the workload and a scoring function ƒ_{q}(c) for each query q∈Q.

At line 1, workload-level configuration candidates V are generated. Lines 2 through 6 execute a for loop wherein for each query q of the set of queries Q, N query-level configurations are generated near the centroid that corresponds to the respective query. Next at line 4, the cartesian product of the M workload-level and N query-level configurations is computed. Next at line 5, based on the surrogate model for the query, and for each workload-level configuration v, the candidate c_{q}*(v) is chosen according to the query-level configuration that maximizes the acquisition function ƒ_{q}. At line 8, each workload-level configuration candidate is scored and summed for all queries in the query workload. And finally at line 10, the optimal workload-level candidate is selected where the sum of the acquisition function across all queries for that candidate is maximized, and the candidate is returned. In the case where the acquisition function corresponds to the execution time, the workload-level configuration returned minimizes the sum of the end-to-end execution time of all queries of the query workload.

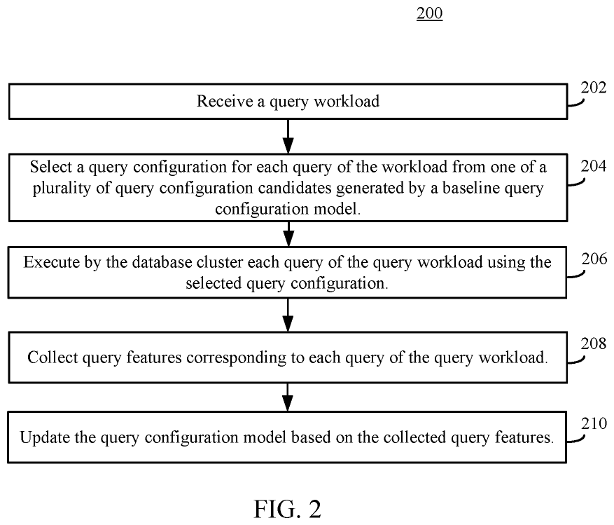

Further operational aspects of database cluster configuration system 100 of FIG. 1 are described as follows in conjunction with FIG. 2. FIG. 2 depicts a flowchart 200 of an example method for operating database cluster configuration system 100, according to an embodiment. Flowchart 200 is described with continued reference to FIG. 1. However, other structural and operational embodiments will be apparent to persons skilled in the relevant art(s) based on the following discussion regarding flowchart 200 of FIG. 2 and database cluster configuration system 100 of FIG. 1.

Flowchart 200 begins at step 202. At step 202, a query workload is received. For example, and with reference to database cluster configuration system 100 as depicted in FIG. 1 and as described above, query workload 180 is received by database compute cluster 165, in an embodiment. Flowchart 200 of FIG. 2 continues at step 204.

In step 204, a query configuration is selected for each query of the workload from one of a plurality of query configuration candidates generated by a baseline query configuration model. For example, and with reference to database cluster configuration system 100 as depicted in FIG. 1 and as described above, query processor 160 is configured to retrieve model 125 which comprises a query configuration model from model store 120. In an embodiment, and as described above, query processor 160 is configured to execute a contextual Bayesian optimization (e.g., by executing Algorithm-1 described herein above) to generate a plurality of query-level configuration candidates in the neighborhood of a centroid configuration based on the query configuration model, and thereafter evaluate an acquisition function for each such candidate wherein the candidate with the highest acquisition function is selected. Flowchart 200 of FIG. 2 continues at step 206.

At step 206, the database cluster executes each query of the query workload using the selected query configuration. For example, and with reference to database cluster configuration system 100 as depicted in FIG. 1 and as described above, query processor 160 is configured to apply query configuration 155 to database compute cluster 165 which in turn executes the corresponding query of query workload 180. Flowchart 200 of FIG. 2 continues at step 208.

In step 208, query features corresponding to each query of the query workload are collected. For example, and with reference to database cluster configuration system 100 as depicted in FIG. 1 and as described above, query event listener 170 of client configuration engine 155 is configured to collect query events 175 from database compute cluster 165 and deliver same to event store 145. In an embodiment, event store 145 processes query events 175 to generate query features 140. Flowchart 200 of FIG. 2 concludes at step 210.

At step 210, the query configuration model updated based on the collected query features. For example, and with reference to database cluster configuration system 100 as depicted in FIG. 1 and as described above, model updater 110 receives query features 140 from event store 145 and uses same to update the query model corresponding to each query and store same back into model store 120.

In the foregoing discussion of steps of flowchart 200, it should be understood that at times, such steps may be performed in a different order or even contemporaneously with other steps. Other operational embodiments will be apparent to persons skilled in the relevant art(s). Note also that the foregoing general description of the operation of database cluster configuration system 100 is provided for illustration only, and embodiments of database cluster configuration system 100 may comprise different hardware, or hardware combined with software and/or firmware, and may operate in manners different than described above. Indeed, steps of flowchart 200 may be performed in various ways.

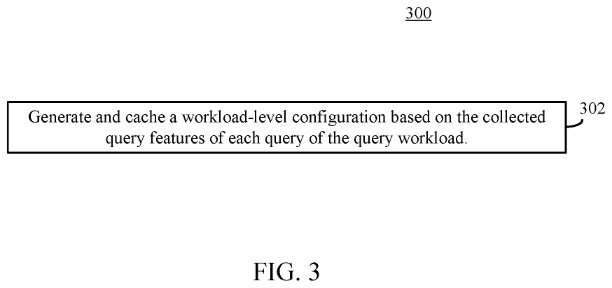

For example, FIG. 3 depicts a flowchart 300 of a refinement to the method of flowchart 200 of FIG. 2, according to an embodiment. Accordingly, flowchart 300 is described with continued reference to FIG. 1. However, other structural and operational embodiments will be apparent to persons skilled in the relevant art(s) based on the following discussion regarding flowchart 300 of FIG. 3 and database cluster configuration system 100 of FIG. 1.

Flowchart 300 begins at step 302. At step 302, a workload-level configuration is generated and cached based on the collected query features of each query of the query workload. For example, and with continued reference to FIG. 1, workload-level configuration generator 130 is configured to receive query features 140 from event store 145 and query models 125 from model store 120, and thereafter perform a joint optimization across all combinations of query-level and workload-level configurations in the manner described above in conjunction with the description of Algorithm-2. The optimum workload-level configuration determined by workload-level configuration generator 130 is thereafter cached in workload-level configuration store 135. In the foregoing discussion of step 302 of flowchart 300, other operational embodiments will be apparent to persons skilled in the relevant art(s).

In the foregoing discussion of steps of flowchart 300, it should be understood that at times, such steps may be performed in a different order or even contemporaneously with other steps. Other operational embodiments will be apparent to persons skilled in the relevant art(s). Indeed, steps of flowchart 300 may be performed in various ways.

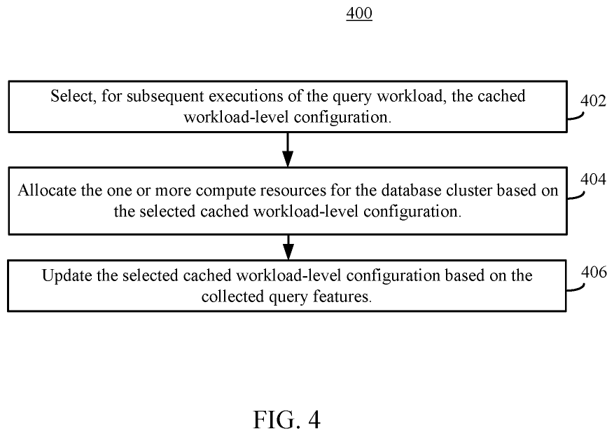

For example, FIG. 4 depicts a flowchart 400 of a refinement to the method of flowcharts 200 and 300 of FIGS. 2 and 3, respectively, according to an embodiment. Accordingly, flowchart 400 is described with continued reference to FIG. 1. However, other structural and operational embodiments will be apparent to persons skilled in the relevant art(s) based on the following discussion regarding flowchart 400 of FIG. 4 and database cluster configuration system 100 of FIG. 1.

Flowchart 400 begins at step 402. At step 402, for subsequent executions of the query workload, the cached workload-level configuration is selected. For example, and with reference to database cluster configuration system 100 as depicted in FIG. 1 and as described above, when the same query workload is executed at a later time, the cached workload-level configuration 150 corresponding to the workload is retrieved from workload-level configuration store 135 and provided to query processor 160. Flowchart 400 of FIG. 4 continues at step 404.

In step 404, one or more compute resources for the database cluster are allocated based on the selected cached workload-level configuration. For example, and with reference to database cluster configuration system 100 as depicted in FIG. 1 and as described above, workload-level configuration 150 specifies various Spark configuration settings such as, for example, the number of compute resource(s) 165-1 to 165-n to use for executing the queries of query workload 180, or the number of processor cores to use for each such resource may be dictated by workload-level configuration 150 and thereafter applied for execution of query workload 180. Flowchart 400 of FIG. 4 concludes at step 406.

In step 406, the selected cached workload-level configuration is updated based on the collected query features. For example, and with reference to database cluster configuration system 100 as depicted in FIG. 1 and as described above, during each subsequent execution of query workload 180, query event listener 170 is configured to gather query events 175 corresponding to each query and provide same to event store 145 as described above in conjunction with flowchart 200 of FIG. 2. Also as described in conjunction with flowchart 200, workload-level configuration generator 130 will thereafter generate an optimal workload-level configuration 150 for query workload 180 and store same in workload-level configuration store 135. In this manner, workload-level configuration 150 is iteratively improved over time and with each execution of query workload 180.

Other operational embodiments will be apparent to persons skilled in the relevant art(s). Note also that the foregoing general description of the operation of database cluster configuration system 100 is provided for illustration only, and database cluster configuration system 100 may comprise different hardware and/or software, and may operate in manners different than described above.

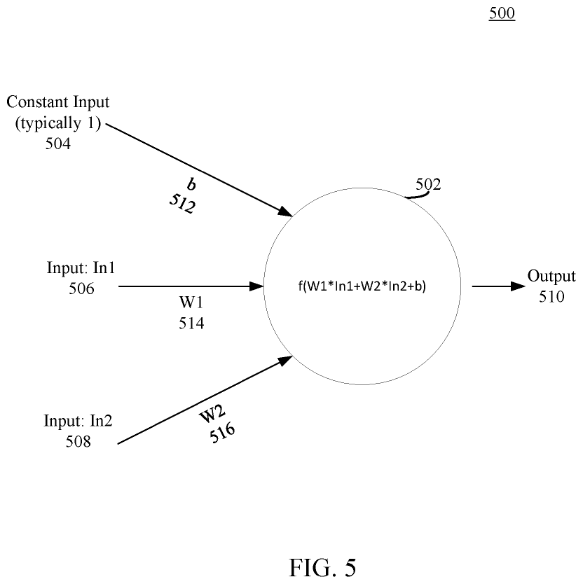

The query models such as query models 125 described above may be implemented in various ways. For example, embodiments may me implemented using a random forest model or a deep neural network (DNN), among others. DNNs may be constructed to perform various inference and optimization tasks. For example, FIG. 5 depicts an example artificial neuron 500 suitable for use in a DNN, according to an embodiment. Neuron 500 includes an activation function 502, a constant input CI 504, an input In1 506, an input In2 508 and output 510. Neuron 500 of FIG. 5 is merely exemplary, and other structural or operational embodiments will be apparent to persons skilled in the relevant art(s) based on the description neuron 500 of FIG. 5, which follows.

Neuron 500 operates by performing activation function 502 on weighted versions of inputs CI 504, In1 506 and In2 508 to produce output 510. Inputs to activation function 502 are weighted according to weights b 512, W1 514 and W2 516. Inputs In1 506 and In2 508 may comprise, for example, normalized or otherwise feature processed data (e.g., images). Activation function 502 is configured to accept a single number (i.e., in this example, the linear combination of weighted inputs) based on all inputs, and to perform a fixed operation. As known by persons skilled in the relevant art(s), such operation may comprise, for example, sigmoid, tanh or rectified linear unit operations. Input CI 504 comprises a constant value (commonly referred to as a ‘bias’) which may typically be set to the value 1, and allows the activation function 502 to include a configurable zero crossing point as known in the relevant art(s).

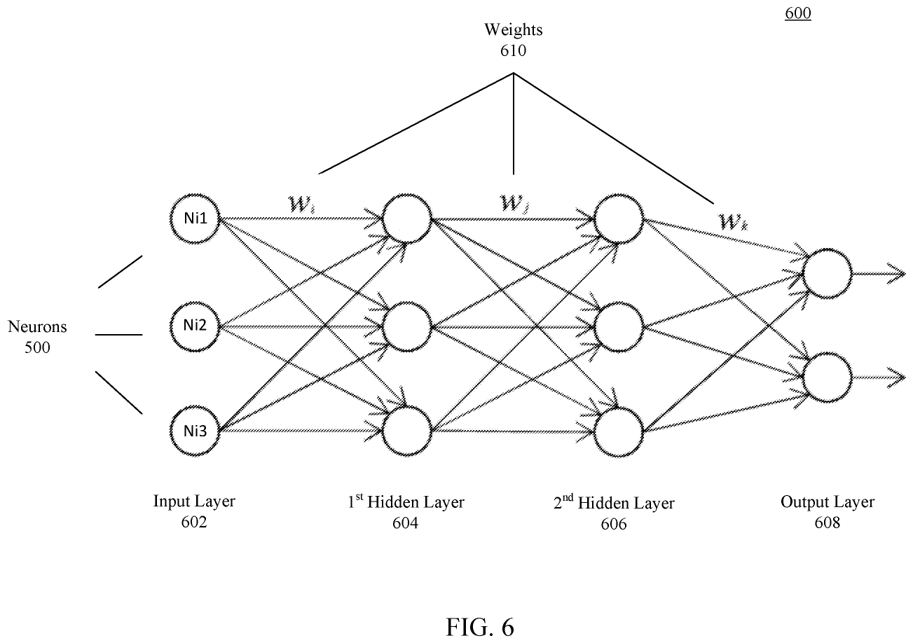

A single neuron generally will accomplish very little, and a useful machine learning model will require the combined computational effort of a large number of neurons working in concert (e.g., ResNet50 with ˜94,000 neurons). For instance, FIG. 6 depicts an example deep neural network (“DNN”) 600 composed of a plurality of neurons 500, according to an embodiment. DNN 600 includes neurons 500 assembled in layers and connected in a cascading fashion. Such layers include an input layer 600, a first hidden layer 604, a second hidden layer 606 and an output layer 608. DNN 600 depicts outputs of each layer of neurons being weighted according to weights 610, and thereafter serving as inputs solely to neurons in the next layer. It should be understood, however, that other strategies for interconnection of neurons 500 are possible in other embodiments, and as is known by persons skilled in the relevant art(s).

The neurons 500 of input layer 602 (labeled Ni1, Ni2 and Ni3) each may be configured to accept normalized or otherwise feature engineered or processed data corresponding to sensor data 106 as described above in relation to neuron 500 of FIG. 5. The output of each neuron 500 of input layer 602 is weighted according to the weight of weights 610 that corresponds to a particular output edge, and is thereafter applied as input at each neuron 500 of 1^{st} hidden layer 604. It should be noted that each edge depicted in DNN 600 corresponds to an independent weight, and labeling of such weights for each edge is omitted for the sake of clarity. In the same fashion, the output of each neuron 500 of first hidden layer 604 is weighted according to its corresponding edge weight, and provided as input to a neuron 500 in 2^{nd} hidden layer 606. Finally, the output of each neuron 500 of second hidden layer 606 is weighted and provided to the inputs of the neurons of output layer 608. The output or outputs of the neurons 500 of output layer 608 comprises the output of the model. In the context of the descriptions above, weight matrix 302 of compressed representation 212 is comprised of weights 610. Note, although output layer 608 includes two neurons 500, embodiments may instead include just a single output neuron 500, and therefore but a single discrete output. Note also, that DNN 600 of FIG. 6 depicts a simplified topology, and typically, producing useful inferences from a DNN like DNN 600 typically requires far more layers, and far more neurons per layer. Thus, DNN 600 should be regarded as a simplified example.

Construction of the above described DNN 600 is part of generating a useful machine learning model. The accuracy of the inferences generated by such a DNN require selection of a suitable activation function, and thereafter the each of the weights of the entire model are adjusted to provide accurate output. The process of adjusting such weights is called “training.” Training a DNN, or other type of neural network, requires a collection of training data of known characteristics. For example, where a DNN is intended to predict the probability that an input image of a piece of fruit is an apple or a pear, the training data would comprise many different images of fruit, and typically including not only apples and pears, but also plums, oranges and other types of fruit. Training requires that the image data corresponding to each image is pre-processed according to normalization and/or feature extraction techniques as known to persons skilled in the relevant art(s) to produce input features for the DNN, and such features are thereafter input to the network. In the example above, such features would be input to the neurons of input layer 602.

Thereafter, each neuron 500 of DNN 600 performs their respective activation function operation, the output of each neuron 500 is weighted and fed forward to the next layer and so forth until outputs are generated by output layer 608. The output(s) of the DNN may thereafter be compared to the known or expected value of the output. The output of the DNN may then be compared to the expected value and the difference fed backward through the network to revise the weights contained therein according to a backward propagation algorithm as known in the art. With the model including revised weights, the same image features may again be input to the model (e.g., neurons 500 of input layer 602 of DNN 600 described above), and new output generated. Training comprises iterating the model over the body of training data and updating the weights at each iteration. Once the model output achieves sufficient accuracy (or outputs have otherwise converged and weight changes are having little effect), the model is said to be trained. A trained model may thereafter be used to evaluate arbitrary input data, the nature of which is not known in advance, nor has the model previously considered (e.g., a new picture of a piece of fruit), and output the desired inference (e.g., the probability that the image is that of an apple).

### III. Example Computer System Implementation

Each of backend configuration engine 105, model updater 110, model store 120, workload-level configuration generator 130, workload-level configuration store 135, event store 145, client configuration engine 155, query processor 160, query event listener 170 and database compute cluster 165, and flowcharts 200, 300 and/or 400 may be implemented in hardware, or hardware combined with software and/or firmware. For example, backend configuration engine 105, model updater 110, model store 120, workload-level configuration generator 130, workload-level configuration store 135, event store 145, client configuration engine 155, query processor 160, query event listener 170 and database compute cluster 165, and flowcharts 200, 300 and/or 400 may be implemented as computer program code/instructions configured to be executed in one or more processors and stored in a computer readable storage medium. Alternatively, backend configuration engine 105, model updater 110, model store 120, workload-level configuration generator 130, workload-level configuration store 135, event store 145, client configuration engine 155, query processor 160, query event listener 170 and database compute cluster 165, and flowcharts 200, 300 and/or 400 may be implemented as hardware logic/electrical circuitry.

For instance, in an embodiment, one or more, in any combination, of backend configuration engine 105, model updater 110, model store 120, workload-level configuration generator 130, workload-level configuration store 135, event store 145, client configuration engine 155, query processor 160, query event listener 170 and database compute cluster 165, and flowcharts 200, 300 and/or 400 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

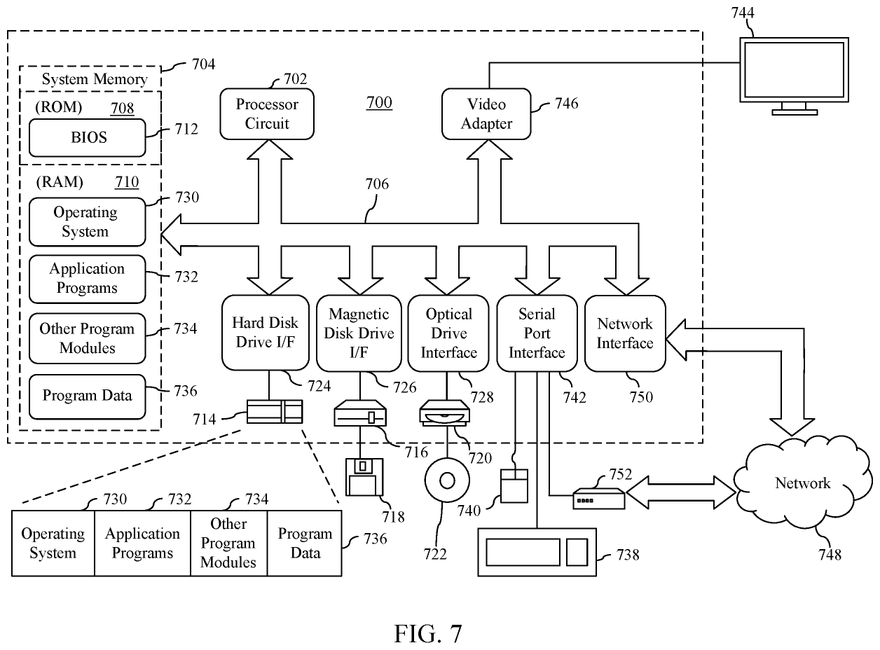

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 7. FIG. 7 shows a block diagram of an exemplary computing environment 700 that includes a computing device 702. Computing device 702 is an example of a computing device in which embodiments may be implemented. In some embodiments, computing device 702 is communicatively coupled with devices (not shown in FIG. 7) external to computing environment 700 via network 704. Network 704 comprises one or more networks such as local area networks (LANs), wide area networks (WANs), enterprise networks, the Internet, etc., and may include one or more wired and/or wireless portions. Network 704 may additionally or alternatively include a cellular network for cellular communications. Computing device 702 is described in detail as follows.

Computing device 702 can be any of a variety of types of computing devices. For example, computing device 702 may be a mobile computing device such as a handheld computer (e.g., a personal digital assistant (PDA)), a laptop computer, a tablet computer, a hybrid device, a notebook computer, a netbook, a mobile phone (e.g., a cell phone or smart phone, etc.), a wearable computing device (e.g., a head-mounted augmented reality and/or virtual reality device including smart glasses, etc.), or other type of mobile computing device. Computing device 702 may alternatively be a stationary computing device such as a desktop computer, a personal computer (PC), a stationary server device, a minicomputer, a mainframe, a supercomputer, etc.

As shown in FIG. 7, computing device 702 includes a variety of hardware and software components, including a processor 710, a storage 720, one or more input devices 730, one or more output devices 750, one or more wireless modems 760, one or more wired interfaces 780, a power supply 782, a location information (LI) receiver 784, and an accelerometer 786. Storage 720 includes memory 756, which includes non-removable memory 722 and removable memory 724, and a storage device 790. Storage 720 also stores an operating system 712, application programs 714, and application data 716. Wireless modem(s) 760 include a Wi-Fi modem 762, a Bluetooth modem 764, and a cellular modem 766. Output device(s) 750 includes a speaker 752 and a display 754. Input device(s) 730 includes a touch screen 732, a microphone 734, a camera 736, a physical keyboard 738, and a trackball 740. Not all components of computing device 702 shown in FIG. 7 are present in all embodiments, additional components not shown may be present, and any combination of the components may be present in a particular embodiment. These components of computing device 702 are described as follows.

A single processor 710 (e.g., central processing unit (CPU), microcontroller, a microprocessor, signal processor, ASIC (application specific integrated circuit), and/or other physical hardware processor circuit) or multiple processors 710 may be present in computing device 702 for performing such tasks as program execution, signal coding, data processing, input/output processing, power control, and/or other functions. Processor 710 may be a single-core or multi-core processor, and each processor core may be single-threaded or multithreaded (to provide multiple threads of execution concurrently). Processor 710 is configured to execute program code stored in a computer readable medium, such as program code of operating system 712 and application programs 714 stored in storage 720. The program code is structured to cause processor 710 to perform operations, including the processes/methods disclosed herein. Operating system 712 controls the allocation and usage of the components of computing device 702 and provides support for one or more application programs 714 (also referred to as “applications” or “apps”). Application programs 714 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 702 can communicate with any other component according to function, although not all connections are shown for ease of illustration. For instance, as shown in FIG. 7, bus 706 is a multiple signal line communication medium (e.g., conductive traces in silicon, metal traces along a motherboard, wires, etc.) that may be present to communicatively couple processor 710 to various other components of computing device 702, although in other embodiments, an alternative bus, further buses, and/or one or more individual signal lines may be present to communicatively couple components. Bus 706 represents one or more of any of several types of bus structures, including a memory bus or memory controller, a peripheral bus, an accelerated graphics port, and a processor or local bus using any of a variety of bus architectures.

Storage 720 is physical storage that includes one or both of memory 756 and storage device 790, which store operating system 712, application programs 714, and application data 716 according to any distribution. Non-removable memory 722 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 722 may include main memory and may be separate from or fabricated in a same integrated circuit as processor 710. As shown in FIG. 7, non-removable memory 722 stores firmware 718, which may be present to provide low-level control of hardware. Examples of firmware 718 include BIOS (Basic Input/Output System, such as on personal computers) and boot firmware (e.g., on smart phones). Removable memory 724 may be inserted into a receptacle of or otherwise coupled to computing device 702 and can be removed by a user from computing device 702. Removable memory 724 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 790 may be present that are internal and/or external to a housing of computing device 702 and may or may not be removable. Examples of storage device 790 include a hard disk drive, a SSD, a thumb drive (e.g., a USB (Universal Serial Bus) flash drive), or other physical storage device.

One or more programs may be stored in storage 720. Such programs include operating system 712, one or more application programs 714, and other program modules and program data. Examples of such application programs may include, for example, computer program logic (e.g., computer program code/instructions) for implementing, utilizing, or supporting operation of one or more of backend configuration engine 105, model updater 110, model store 120, workload-level configuration generator 130, workload-level configuration store 135, event store 145, client configuration engine 155, query processor 160, query event listener 170 and database compute cluster 165, and flowcharts 200, 300 and/or 400 (including any suitable step of flowcharts 200, 300 and/or 400) described herein, including portions thereof, and/or further examples described herein.

Storage 720 also stores data used and/or generated by operating system 712 and application programs 714 as application data 716. Examples of application data 716 include web pages, text, images, tables, sound files, video data, and other data, which may also be sent to and/or received from one or more network servers or other devices via one or more wired or wireless networks. Storage 720 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 702 through one or more input devices 730 and may receive information from computing device 702 through one or more output devices 750. Input device(s) 730 may include one or more of touch screen 732, microphone 734, camera 736, physical keyboard 738 and/or trackball 740 and output device(s) 750 may include one or more of speaker 752 and display 754. Each of input device(s) 730 and output device(s) 750 may be integral to computing device 702 (e.g., built into a housing of computing device 702) or external to computing device 702 (e.g., communicatively coupled wired or wirelessly to computing device 702 via wired interface(s) 780 and/or wireless modem(s) 760). Further input devices 730 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 754 may display information, as well as operating as touch screen 732 by receiving user commands and/or other information (e.g., by touch, finger gestures, virtual keyboard, etc.) as a user interface. Any number of each type of input device(s) 730 and output device(s) 750 may be present, including multiple microphones 734, multiple cameras 736, multiple speakers 752, and/or multiple displays 754.

One or more wireless modems 760 can be coupled to antenna(s) (not shown) of computing device 702 and can support two-way communications between processor 710 and devices external to computing device 702 through network 704, as would be understood to persons skilled in the relevant art(s). Wireless modem 760 is shown generically and can include a cellular modem 766 for communicating with one or more cellular networks, such as a GSM network for data and voice communications within a single cellular network, between cellular networks, or between the mobile device and a public switched telephone network (PSTN). Wireless modem 760 may also or alternatively include other radio-based modem types, such as a Bluetooth modem 764 (also referred to as a “Bluetooth device”) and/or Wi-Fi modem 762 (also referred to as an “wireless adaptor”). Wi-Fi modem 762 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 764 is configured to communicate with another Bluetooth-capable device according to the Bluetooth short-range wireless technology standard(s) such as IEEE 802.15.1 and/or managed by the Bluetooth Special Interest Group (SIG).

Computing device 702 can further include power supply 782, LI receiver 784, accelerometer 786, and/or one or more wired interfaces 780. Example wired interfaces 780 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 780 of computing device 702 provide for wired connections between computing device 702 and network 704, or between computing device 702 and one or more devices/peripherals when such devices/peripherals are external to computing device 702 (e.g., a pointing device, display 754, speaker 752, camera 736, physical keyboard 738, etc.). Power supply 782 is configured to supply power to each of the components of computing device 702 and may receive power from a battery internal to computing device 702, and/or from a power cord plugged into a power port of computing device 702 (e.g., a USB port, an A/C power port). LI receiver 784 may be used for location determination of computing device 702 and may include a satellite navigation receiver such as a Global Positioning System (GPS) receiver or may include other type of location determiner configured to determine location of computing device 702 based on received information (e.g., using cell tower triangulation, etc.). Accelerometer 786 may be present to determine an orientation of computing device 702.

Note that the illustrated components of computing device 702 are not required or all-inclusive, and fewer or greater numbers of components may be present as would be recognized by one skilled in the art. For example, computing device 702 may also include one or more of a gyroscope, barometer, proximity sensor, ambient light sensor, digital compass, etc. Processor 710 and memory 756 may be co-located in a same semiconductor device package, such as being included together in an integrated circuit chip, FPGA, or system-on-chip (SOC), optionally along with further components of computing device 702.

In embodiments, computing device 702 is configured to implement any of the above-described features of flowcharts herein. Computer program logic for performing any of the operations, steps, and/or functions described herein may be stored in storage 720 and executed by processor 710.

In some embodiments, server infrastructure 770 may be present in computing environment 700 and may be communicatively coupled with computing device 702 via network 704. Server infrastructure 770, when present, may be a network-accessible server set (e.g., a cloud-based environment or platform). As shown in FIG. 7, server infrastructure 770 includes clusters 772. Each of clusters 772 may comprise a group of one or more compute nodes and/or a group of one or more storage nodes. For example, as shown in FIG. 7, cluster 772 includes nodes 774. Each of nodes 774 are accessible via network 704 (e.g., in a “cloud-based” embodiment) to build, deploy, and manage applications and services. Any of nodes 774 may be a storage node that comprises a plurality of physical storage disks, SSDs, and/or other physical storage devices that are accessible via network 704 and are configured to store data associated with the applications and services managed by nodes 774. For example, as shown in FIG. 7, nodes 774 may store application data 778.

Each of nodes 774 may, as a compute node, comprise one or more server computers, server systems, and/or computing devices. For instance, a node 774 may include one or more of the components of computing device 702 disclosed herein. Each of nodes 774 may be configured to execute one or more software applications (or “applications”) and/or services and/or manage hardware resources (e.g., processors, memory, etc.), which may be utilized by users (e.g., customers) of the network-accessible server set. For example, as shown in FIG. 7, nodes 774 may operate application programs 776. In an implementation, a node of nodes 774 may operate or comprise one or more virtual machines, with each virtual machine emulating a system architecture (e.g., an operating system), in an isolated manner, upon which applications such as application programs 776 may be executed.

In an embodiment, one or more of clusters 772 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 772 may be a datacenter in a distributed collection of datacenters. In embodiments, exemplary computing environment 700 comprises part of a cloud-based platform.

In an embodiment, computing device 702 may access application programs 776 for execution in any manner, such as by a client application and/or a web browser at computing device 702.

For purposes of network (e.g., cloud) backup and data security, computing device 702 may additionally and/or alternatively synchronize copies of application programs 714 and/or application data 716 to be stored at network-based server infrastructure 770 as application programs 776 and/or application data 778. For instance, operating system 712 and/or application programs 714 may include a file hosting service client configured to synchronize applications and/or data stored in storage 720 at network-based server infrastructure 770.

In some embodiments, on-premises servers 792 may be present in computing environment 700 and may be communicatively coupled with computing device 702 via network 704. On-premises servers 792, when present, are hosted within an organization's infrastructure and, in many cases, physically onsite of a facility of that organization. On-premises servers 792 are controlled, administered, and maintained by IT (Information Technology) personnel of the organization or an IT partner to the organization. Application data 798 may be shared by on-premises servers 792 between computing devices of the organization, including computing device 702 (when part of an organization) through a local network of the organization, and/or through further networks accessible to the organization (including the Internet). Furthermore, on-premises servers 792 may serve applications such as application programs 796 to the computing devices of the organization, including computing device 702. Accordingly, on-premises servers 792 may include storage 794 (which includes one or more physical storage devices such as storage disks and/or SSDs) for storage of application programs 796 and application data 798 and may include one or more processors for execution of application programs 796. Still further, computing device 702 may be configured to synchronize copies of application programs 714 and/or application data 716 for backup storage at on-premises servers 792 as application programs 796 and/or application data 798.

Embodiments described herein may be implemented in one or more of computing device 702, network-based server infrastructure 770, and on-premises servers 792. For example, in some embodiments, computing device 702 may be used to implement systems, clients, or devices, or components/subcomponents thereof, disclosed elsewhere herein. In other embodiments, a combination of computing device 702, network-based server infrastructure 770, and/or on-premises servers 792 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 720. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 714) may be stored in storage 720. Such computer programs may also be received via wired interface(s) 780 and/or wireless modem(s) 760 over network 704. Such computer programs, when executed or loaded by an application, enable computing device 702 to implement features of embodiments discussed herein. Accordingly, such computer programs represent controllers of the computing device 702.

Embodiments are also directed to computer program products comprising computer code or instructions stored on any computer-readable medium or computer-readable storage medium. Such computer program products include the physical storage of storage 720 as well as further physical storage types.

### IV. Additional Example Embodiments

A method of operating a database cluster comprising one or more compute resources configured to perform database queries is provided herein. In an embodiment, the method comprises: receiving a query workload; selecting a query configuration for each query of the workload from one of a plurality of query configuration candidates generated by a baseline query configuration model; executing by the database cluster each query of the query workload using the selected query configuration; collecting query features corresponding to each query of the query workload; and updating the query configuration model based on the collected query features.

In an embodiment of the foregoing method, the baseline query configuration model is configured to select the plurality of query configuration candidates based on execution measurements of a plurality of predetermined query workloads comprising a plurality of queries, executed across a predetermined matrix of configurations.

In an embodiment of the foregoing method, the selection of the plurality of query configuration candidates is based on a centroid learning algorithm wherein the plurality of query configuration candidates comprises candidates in a neighborhood of a current centroid configuration.

In an embodiment of the foregoing method, the execution measurements comprise at least one of: a query execution time, a memory requirement, or a compute resource requirement.

In an embodiment of the foregoing method, the method further comprises generating and caching a workload-level configuration based on the collected query features of each query of the query workload.

In an embodiment of the foregoing method, said generating a workload-level configuration is further based on the collected query features of each query of the query workload such that execution time for the query workload is minimized.

In an embodiment of the foregoing method, the method further comprises: selecting, for subsequent executions of the query workload, the cached workload-level configuration; allocating the one or more compute resources for the database cluster based on the selected cached workload-level configuration; updating the selected cached workload-level configuration based on the collected query features.

A database cluster configuration system including a database cluster comprising one or more compute resources configured to perform database queries is provided herein. In an embodiment, the system comprises: a backend configuration engine including an event store, a model store and a model updater; a client configuration engine, including a query processor and a query event listener component, the query processor coupled to the model store and configured to receive one or more query configuration models therefrom, the client configuration engine further coupled to the database cluster and wherein the client configuration engine is configured to: receive a query workload; select, through the query processor, a query configuration for each query of the query workload from a plurality of query configuration candidates generated by a baseline query configuration model received from the model store; and execute by the database cluster each query of the query workload using the selected query configuration; wherein the query event listener is configured to collect query events corresponding to each executed query of the query workload, and to provide the query events to the event store; and wherein the model updater is configured to receive the query features from the events store and to update the query configuration model based on the query features.

In an embodiment of the foregoing database cluster configuration system, the baseline query configuration model is configured to select the plurality of query configuration candidates based on execution measurements of a plurality of predetermined query workloads comprising a plurality of queries, executed across a predetermined matrix of configurations.

In an embodiment of the foregoing database cluster configuration system, the database cluster configuration system of claim 9, wherein the selection of the plurality of query configuration candidates is based on a centroid learning algorithm wherein the plurality of query configuration candidates comprises candidates in a neighborhood of a current centroid configuration.

In an embodiment of the foregoing database cluster configuration system, the execution measurements comprise at least one of: a query execution time, a memory requirement, or a compute resource requirement.

In an embodiment of the foregoing database cluster configuration system, the backend configuration engine further comprises: a workload-level configuration generator and a workload-level configuration store, the workload-level configuration generator configured to generate and cache a workload-level configuration based on the collected query features of each query of the query workload, and thereafter store said workload-level configuration in the workload-level configuration store.

In an embodiment of the foregoing database cluster configuration system, the workload-level configuration generator is further configured to generate the workload-level configuration workload-level configuration based on the collected query features of each query of the query workload such that execution time for the query workload is minimized.

In an embodiment of the foregoing database cluster configuration system, the client configuration engine is further configured to: select, for subsequent executions of the query workload, the cached workload-level configuration from the workload-level configuration store; and allocate the one or more compute resources for the database cluster based on the selected cached workload-level configuration; and wherein the backend configuration engine is further configured to update the selected cached workload-level configuration based on the collected query features.

A computer-readable memory device is provided herein, the computer-readable memory device having computer program logic recorded thereon that when executed by at least one processor of a computing device causes the at least one processor to perform operations. In an embodiment, the operations comprise: receiving a query workload; selecting a query configuration for each query of the query workload from a plurality of query configuration candidates generated by a baseline query configuration model; executing by the database cluster each query of the query workload using the selected query configuration; collecting query features corresponding to each query of the query workload; and updating the query configuration model based on the collected query features.

In an embodiment of the foregoing computer-readable memory device, the baseline query configuration model is configured to select the plurality of query configuration candidates based on execution measurements of a plurality of predetermined query workloads comprising a plurality of queries, executed across a predetermined matrix of configurations.

In an embodiment of the foregoing computer-readable memory device, the selection of the plurality of query configuration candidates is based on a centroid learning algorithm wherein the plurality of query configuration candidates comprises candidates in a neighborhood of a current centroid configuration.

In an embodiment of the foregoing computer-readable memory device, the operations further comprise: generating and caching a workload-level configuration based on the collected query features of each query of the query workload.

In an embodiment of the foregoing computer-readable memory device, said generating a workload-level configuration is further based on the collected query features of each query of the query workload such that execution time for the query workload is minimized.

In an embodiment of the foregoing computer-readable memory device, the operations further comprise: selecting, for subsequent executions of the query workload, the cached workload-level configuration; allocating the one or more compute resources for the database cluster based on the selected cached workload-level configuration; updating the selected cached workload-level configuration based on the collected query features.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (e.g., or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (e.g., computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

1. A computer-implemented method of configuring a database cluster comprising one or more compute resources configured to perform database queries, comprising:
receiving a query workload;
determining a query configuration for the query workload from one of a plurality of query configuration candidates generated by a baseline query configuration model;
allocating the one or more compute resources of the database cluster based on the determined query configuration;
executing, by the database cluster, the query workload using the allocated compute resources;
collecting query features corresponding to each query of the query workload; and
providing the query features to enable updating of the query configuration model based on the collected query features.

2. The computer-implemented method of claim 1, wherein the baseline query configuration model is configured to select the plurality of query configuration candidates based on execution measurements of a plurality of predetermined query workloads comprising a plurality of queries, executed across a predetermined matrix of configurations.

3. The computer-implemented method of claim 2, wherein the selection of the plurality of query configuration candidates is based on a centroid learning algorithm wherein the plurality of query configuration candidates comprises candidates in a neighborhood of a current centroid configuration.

4. The computer-implemented method of claim 2, wherein the execution measurements comprise at least one of: a query execution time, a memory requirement, or a compute resource requirement.

5. The computer-implemented method of claim 4, further comprising:
generating and caching a workload-level configuration based on the collected query features.

6. The computer-implemented method of claim 5, wherein said generating a workload-level configuration is further based on the collected query features of each query of the query workload such that execution time for the query workload is minimized.

7. The computer-implemented method of claim 6 further comprising:
selecting, for subsequent executions of the query workload, the cached workload-level configuration;
allocating the one or more compute resources for the database cluster based on the selected cached workload-level configuration;
updating the selected cached workload-level configuration based on the collected query features.

8. A database cluster configuration system including a database cluster comprising one or more compute resources configured to perform database queries, the system comprising:
a backend configuration engine including an event store, a model store and a model updater;
a client configuration engine, including a query processor and a query event listener component, the query processor coupled to the model store and configured to receive one or more query configuration models therefrom, the client configuration engine further coupled to the database cluster and wherein the client configuration engine is configured to:
receive a query workload;
determine, through the query processor, a query configuration for the query workload from a plurality of query configuration candidates generated by a baseline query configuration model received from the model store;
allocate the one or more compute resources of the database cluster based on the selected query configuration; and
execute, by the database cluster, the query workload using the allocated compute resources;
wherein the query event listener is configured to collect query events corresponding to each executed query of the query workload, and to provide the query events to the event store; and
wherein the model updater is configured to receive the query features from the events store and to update the query configuration model based on the query features.

9. The database cluster configuration system of claim 8, wherein the baseline query configuration model is configured to select the plurality of query configuration candidates based on execution measurements of a plurality of predetermined query workloads comprising a plurality of queries, executed across a predetermined matrix of configurations.

10. The database cluster configuration system of claim 9, wherein the selection of the plurality of query configuration candidates is based on a centroid learning algorithm wherein the plurality of query configuration candidates comprises candidates in a neighborhood of a current centroid configuration.

11. The database cluster configuration system of claim 9, wherein the execution measurements comprise at least one of: a query execution time, a memory requirement, or a compute resource requirement.

12. The database cluster configuration system of claim 11 wherein the backend configuration engine further comprises:
a workload-level configuration generator and a workload-level configuration store, the workload-level configuration generator configured to generate and cache a workload-level configuration based on the collected query features of each query of the query workload, and store said workload-level configuration in the workload-level configuration store.

13. The database cluster configuration system of claim 12, wherein the workload-level configuration generator is further configured to generate the workload-level configuration workload-level configuration based on the collected query features of each query of the query workload such that execution time for the query workload is minimized.

14. The database cluster configuration system of claim 12, wherein the client configuration engine is further configured to:
select, for subsequent executions of the query workload, the cached workload-level configuration from the workload-level configuration store; and
allocate the one or more compute resources for the database cluster based on the selected cached workload-level configuration; and
wherein the backend configuration engine is further configured to update the selected cached workload-level configuration based on the collected query features.

15. A computer-readable memory device having computer program logic recorded thereon that when executed by at least one processor of a computing device causes the at least one processor to perform operations, the operations comprising:
receiving a query workload;
determining a query configuration for the query workload from a plurality of query configuration candidates generated by a baseline query configuration model;
allocating the one or more compute resources of the database cluster based on the selected query configuration;
executing, by the database cluster, the query workload using the allocated compute resources;
collecting query features corresponding to each query of the query workload; and
providing the query features to enable updating of the query configuration model based on the collected query features.

16. The computer-readable memory device of claim 15, wherein the baseline query configuration model is configured to select the plurality of query configuration candidates based on execution measurements of a plurality of predetermined query workloads comprising a plurality of queries, executed across a predetermined matrix of configurations.

17. The computer-readable memory device of claim 16, wherein the selection of the plurality of query configuration candidates is based on a centroid learning algorithm wherein the plurality of query configuration candidates comprises candidates in a neighborhood of a current centroid configuration.

18. The computer-readable memory device of claim 17, wherein the operations further comprise:
generating and caching a workload-level configuration based on the collected query features of each query of the query workload.

19. The computer-readable memory device of claim 18, wherein said generating a workload-level configuration is further based on the collected query features of each query of the query workload such that execution time for the query workload is minimized.

20. The computer-readable memory device of claim 18, wherein the operations further comprise:
selecting, for subsequent executions of the query workload, the cached workload-level configuration;
allocating the one or more compute resources for the database cluster based on the selected cached workload-level configuration;
updating the selected cached workload-level configuration based on the collected query features.
